(19) United States
(12) Patent Application Publication
(10) Pub. No.: US 2003/0131521 A1
(43) Pub. Date: Jul. 17, 2003

(54) Spinnow fishing lure

(76) Inventor: Paul Ramsay Steeves, Sharbot Lake (CA)

Correspondence Address: Paul Ramsay Steeves, 1092 Garrett Street, Box 124, Sharbot Lake, ON, CA

(21) Appl. No.: 10/162,814

(22) Filed: Jun. 6, 2002

(30) Foreign Application Priority Data
Jan. 11, 2002 (CA) 2,367,891

(51) Int. Cl. A01K 85/00

(52) U.S. Cl. 43/42.51

(57) ABSTRACT

The invention entitled “Spinnow” is a fishing lure that is shaped like a minnow. It has contours within the tail of the minnow shape that causes the lure to spin around the axis along its length when drawn through the water. The tail fins are curved perpendicularly to the length of the lure. The invention “Spinnow” is made of any hard or rigid material such as metal or any synthetic product such as some plastics. There is a fishing hook attached to the rear of the lure.

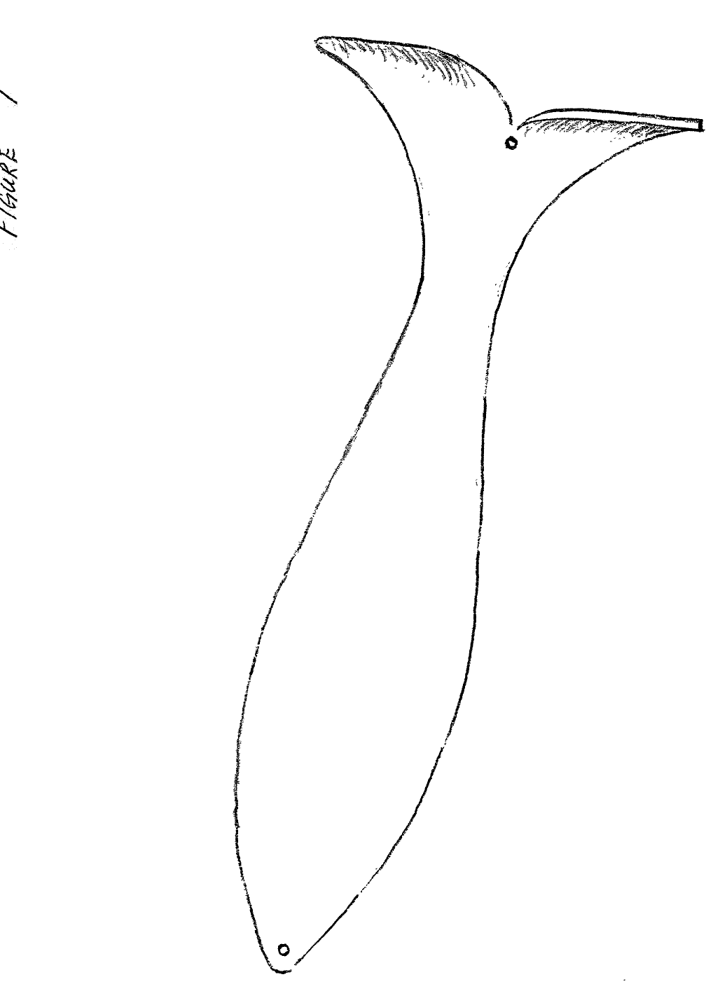

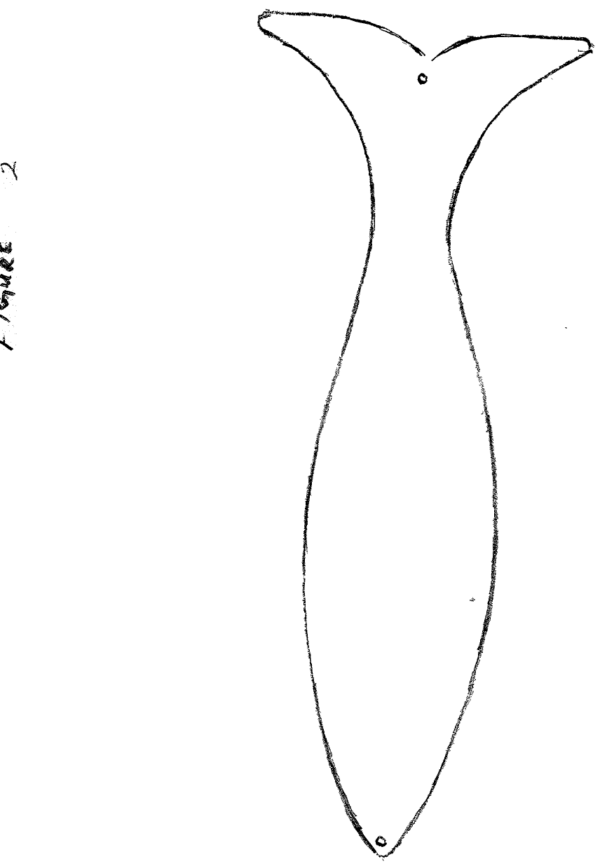

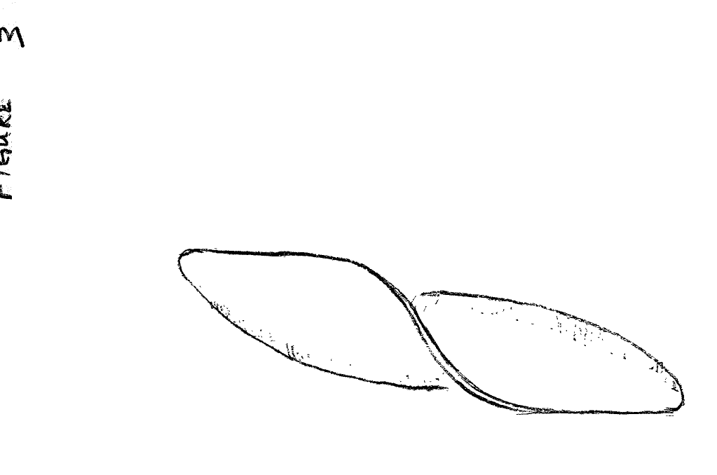

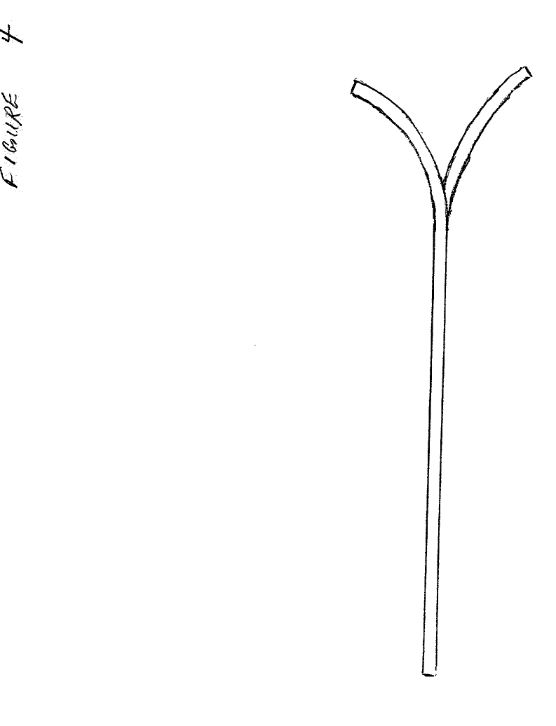

### DESCRIPTION

1) Spinning minnow shaped fishing lure.

2) Spinning fishing lure that is shaped like a minnow to attract and catch fish.

3) The minnow shape is made from any rigid material such as metal, or a synthetic product such as some plastics. The tail fins of the fishing lure are bent or curved perpendicular to the length (see figure #1 for a side on picture of the lure including the bends in the tail. See figure #3 which is looking straight down the back of the lure at the bends in the tail. Figure #4 is looking down at top.)

4) The invention “Spinnow” addresses the use of artificial bait for the purposes of catching fish.

5) This invention called “Spinnow” effectively attracts and catches fish.

6) Drawings: see figures numbers one, two and three and four. Figures number one shows the tail section side on, and figure number three shows the tail section looking straight at the back of the lure. Figure two depicts the minnow shape. Figure four is looking down at the top of the lure.

7) The invention is a fishing lure

8) It is shaped like a minnow.

9) The tail fins are curved perpendicularly to the length of the minnow shape causing the lure to spin along the axis through its length when the lure is drawn through the water.

10) The intended use of this invention is to attract, hook and land a fish.

11) There is no sequence listing.

1. The invention entitled “Spinnow” is a fishing lure that has a profile that looks like a minnow consisting of curves in the tail of the minnow shape causing it to spin about its length when drawn through the water in order to attract and hook a fish.
